(19) United States
(12) Patent Application Publication
(10) Pub. No.: US 2007/0115785 A1
(43) Pub. Date: May 24, 2007

(54) Information reproducing apparatus

(75) Inventor: Tetsuya Shihara, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/602,300

(22) Filed: Nov. 21, 2006

(30) Foreign Application Priority Data
Nov. 24, 2005 (JP) 2005-338070

(51) Int. Cl. G11B 20/10

(52) U.S. Cl. 369/59.22

(57) ABSTRACT

An information reproducing apparatus comprises an optical head that reads the lengths and arrangement of recording marks recorded on an optical disc and outputs RF signals, a PRML decoder that decodes binary data based on the RF signals output from the optical head, a short mark asymmetry measuring unit that measures an asymmetry in an RF signal of the RF signals output from the optical head that corresponds to a 2T mark or shortest recording mark, and an RF signal offset unit that offsets the RF signals so as to remove the asymmetry in the RF signal corresponding to the 2T mark based on the measurement by the short mark asymmetry measuring unit. The PRML decoder decodes the binary data based on the RF signals offset by the RF signal offset unit. The information reproducing apparatus can provide improved performance in reproduction of information recorded on an optical disc.

### BACKGROUND OF THE INVENTION

1. Field of the Invention

The present invention relates to information reproducing apparatus that reproduce information recorded on a recording medium such as an optical disc or a hard disk.

2. Description of the Related Art

Optical discs store information by an arrangement of several types of recording marks having different lengths. With a basic recording cycle T, recording marks of lengths 3T to 14T are used. In a high-density optical disc using blue laser or the like (Blu-ray Disc (BD)), 2T marks are used as the shortest recording marks. Information on an optical disc is reproduced by reading recording marks recorded on the optical disc, acquiring RF signals (reproduced signals) corresponding to the lengths and arrangement of the recording marks, and then decoding binary data represented by the lengths and arrangement of the recording marks recorded on the optical disc based on the acquired RF signals.

Methods for decoding binary data include the level slice method and the partial response maximum likelihood (PRML) method. In the level slice method, data is decoded by comparing an RF signal with a predetermined threshold level to determine whether the RF signal is higher or lower than the threshold level. In the PRML method, data is decoded by comparing an RF signal with all expected waveforms to identify an expected waveform closest to the RF signal. The PRML method is suitable for decoding binary data from a high-density optical disc.

If there is an asymmetry in an RF signal, a waveform caused by a recording mark may not be able to be distinguished from a waveform caused by a noise. Therefore, the error rate in decoding binary data may increase, so that the reproduction performance may be deteriorated. This problem is more significant in the PRML method. For decoding binary data, it is necessary to generate, at a PLL circuit, a clock for reproduction that synchronizes with the basic recording cycle of recording marks based on an RF signal, and to sample the RF signal in accordance with the timing of the reproduction clock. An RF signal is digitized for the generation of the reproduction clock at the PLL circuit. Accordingly, an asymmetry in an RF signal increases the error and jitters in a signal generated by digitizing the RF signal and thus deteriorates the pull-in performance of the PLL circuit. This also increases the error rate in decoding binary data, thus deteriorating the reproduction performance.

Japanese laid-open patent publication 2000-243032 discloses an information reproducing apparatus that is designed to offset or control the DC level of an RF signal in view of asymmetries in RF signals. Japanese laid-open patent publication 2005-93033 discloses an information reproducing apparatus that is designed to switch its method for decoding binary data between the level slice method and the PRML method in accordance with the distortion rate of recording marks and the asymmetry rate of RF signals. Further, Japanese laid-open patent publication 2003-85764 discloses an information reproducing apparatus that is designed to change the PR equalization characteristic in the PRML decoding method in response to the respective asymmetries in recording-mark portions and no-recording-mark portions.

An asymmetry in an RF signal is more likely to occur as the length of the recording mark decreases. In other words, a short mark, which is the shortest recording mark, is more likely to have an asymmetry in the RF signal. Further, in a popular code modulation system for optical discs, a shorter recording mark is more likely to occur. Thus, the short mark, which is the shortest recording mark, is most likely to occur.

However, in the information reproducing apparatus disclosed in laid-open patent publication 2000-243032, no consideration is given to the DC level offset for RF signals that specifically takes account of asymmetries in short marks or shortest recording marks. Therefore, the information reproducing apparatus disclosed in laid-open patent publication 2000-243032 may decrease asymmetries in RF signals as a whole but may still have asymmetries in RF signals corresponding to short marks. As a result, in accordance with the probability of occurrence of short marks, which are most likely to occur, the error rate in decoding binary data increases to deteriorate the reproduction performance. Even with the techniques disclosed in Japanese laid-open patent publications 2005-93033 and 2003-85764, the above described problem cannot be solved.

### SUMMARY OF THE INVENTION

An object of the present invention is to provide an information reproducing apparatus that can have improved performance for reproducing information on a recording medium.

According to an aspect of the present invention, this object is achieved by an information reproducing apparatus comprising: reading means for reading lengths and arrangement of recording marks from a recording medium on which several types of recording marks having different lengths are recorded in an arrangement to represent binary data, and outputting reproduced signals corresponding to the lengths and arrangement of the recording marks; decoding means for decoding the binary data represented by the lengths and arrangement of the recording marks on the recording medium based on the reproduced signals output from the reading means; asymmetry measuring means for measuring an asymmetry in a reproduced signal of the reproduced signals output from the reading means that corresponds to a short mark, the short mark being a shortest recording mark among the several types of recording marks; and signal offset means for offsetting the reproduced signals so as to remove the asymmetry in the reproduced signal corresponding to the short mark based on the measurement by the asymmetry measuring means.

In this information reproducing apparatus, the decoding means decodes the binary data based on the reproduced signals offset by the signal offset means.

With this configuration, reproduced signals are offset so as to remove asymmetries in reproduced signals corresponding to the short mark or shortest recording mark, which is most likely to occur. Binary data is decoded based on the reproduced signals. Therefore, the error rate in decoding binary data can be decreased for improved performance in reproduction of information on a recording medium. Accordingly, stable reproduction of information and a reliable system can be provided.

Preferably, the decoding means is a partial response maximum likelihood (PRML) decoder that decodes binary data by a PRML method, and, taking T as a basic recording cycle for recording marks on the recording medium, the short mark is a 2T mark having a length of 2T.

Since the short mark as the shortest recording mark is the 2T mark and the PRML method is adopted for decoding binary data, the information reproducing apparatus is suitable for reproducing information on a high-density recording medium. Accordingly, the information reproducing apparatus can provide further improved performance in reproduction of information on a high-density recording medium.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram schematically showing the configuration of an information reproducing apparatus according to one embodiment of the present invention; and

FIG. 2 is a flowchart showing the operation of the information reproducing apparatus.

### DESCRIPTION OF THE PREFERRED EMBODIMENTS

Referring now to the accompanying drawings, an information reproducing apparatus embodying the present invention is described. It is to be noted that the following description of preferred embodiment of the present invention has been presented for purposes of illustration and description, and is not intended to be exhaustive or to limit the present invention to the precise form disclosed.

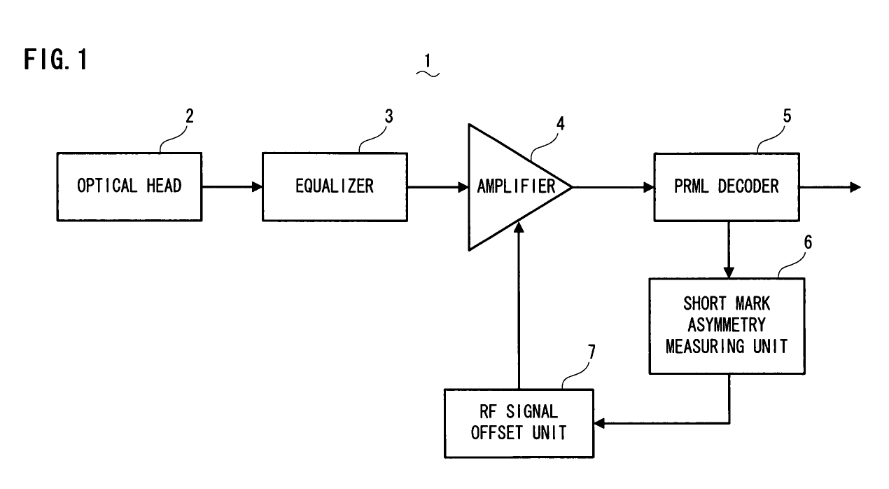

FIG. 1 shows the configuration of the information reproducing apparatus according to this embodiment. The information reproducing apparatus 1 is an apparatus that reproduces information on an optical disc on which information is recorded in the form of several types of recording marks having different lengths 2T to 14T (T represents the basic recording cycle for recording marks), e.g., a high-density optical disc using blue laser or the like (BD: Blu-ray Disc), by adopting the partial response maximum likelihood (PRML) decoding method. This information reproducing apparatus 1 comprises an optical head (reading means) 2, an equalizer 3, an amplifier 4, a PRML decoder 5, a short mark asymmetry measuring unit 6, and an RF signal offset unit 7.

The optical head 2 reads the lengths and arrangement of recording marks recorded on an optical disc by emitting light onto the optical disc and receiving the reflected light, and outputs RF signals (reproduced signals) corresponding to the lengths and arrangement of the recording marks. Recorded on the optical disc is an arrangement of several types of recording marks having different lengths of 2T to 14T for representation of binary data. The equalizer 3 boosts an RF signal output from the optical head 2 and cuts off the noise frequency component contained in the RF signal for equalization of the waveform of the RF signal. The amplifier 4 amplifies an RF signal having a waveform equalized by the equalizer 3.

The PRML decoder 5 decodes binary data by the PRML method based on an RF signal amplified by the amplifier 4. The PRML method is a decoding method of decoding binary data by comparing an RF signal with all expected waveforms to identify an expected waveform closest to the RF signal.

The PRML decoder 5 comprises a digitizing circuit, a PLL circuit, an A/D converter, a PR equalizer, a Viterbi decoder, and so on (not shown). The PRML decoder 5 digitizes an RF signal amplified by the amplifier 4 at a predetermined digitization level by the digitizing circuit, and generates, at the PLL circuit, a reproduction clock synchronizing with the basic recording cycle of recording marks recorded on an optical disc by using the digitized output as an input signal to the PLL circuit. Then, at the A/D converter, the PRML decoder 5 samples the RF signal amplified by the amplifier 4 based on the reproduction clock generated at the PLL circuit for conversion into a digital RF signal. Further, the PRML decoder 5 equalizes the digital RF signal into a signal of a waveform having a predetermined PR characteristic by means of the PR equalizer, and decodes binary data based on the PR equalized digital RF signal by means of the Viterbi decoder. The Viterbi decoder decodes binary data by comparing the PR equalized digital RF signal with all expected waveforms based on the reproduction clock generated at the PLL circuit so as to identify a closest expected waveform. Binary data decoded by the PRML decoder 5 is then processed by an information reproducing unit (not shown), so that information recorded on the optical disc is reproduced.

The short mark asymmetry measuring unit 6 measures/calculates an asymmetry in an RF signal of RF signals output from the optical head 2 that corresponds to a 2T mark (short mark), which is the shortest recording mark. If the PLL circuit is not in lock, an AGC (not shown) at the A/D converter is in operation. Therefore, the measurement/calculation of an asymmetry in an RF signal corresponding to the 2T mark by the short mark asymmetry measuring unit 6 is performed by determining the amplitude of the RF signal amplified by the amplifier 4. Otherwise, if the PLL circuit is in lock, the measurement/calculation is performed based on the result of a sampling at the A/D converter.

The RF signal offset unit 7 offsets RF signals based on a measurement by the asymmetry measuring unit 6 so as to remove an asymmetry in an RF signal corresponding to the 2T mark, i.e., to adjust the level at the center of positive and negative of the RF signal corresponding to the 2T mark (reference level for detection of asymmetries) to the digitization level at the digitizing circuit. The RF signal offset by the RF signal offset unit 7 is performed by changing the gain of the amplifier 4.

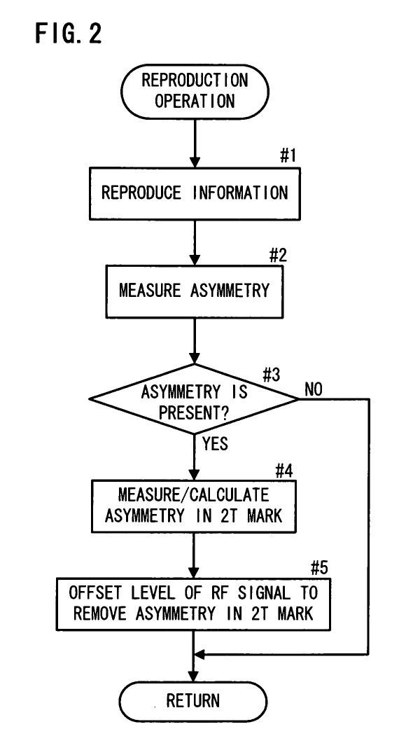

FIG. 2 is a flowchart showing the operation of the above described information reproducing apparatus 1. First, the information reproducing apparatus 1 reproduces information on an optical disc (#1). More particularly, the information reproducing apparatus 1 reads the lengths and arrangement of recording marks recorded on the optical disc by means of the optical head 2, and decodes binary data based on an RF signal output from the optical head 2 by means of the PRML decoder 5 so as to reproduce information recorded on the optical disc.

Subsequently, the information reproducing apparatus 1 measures an asymmetry in an RF signal output from the optical head 2 (#2). If there is an asymmetry (YES at #3), the information reproducing apparatus 1 measures/calculates an asymmetry in a 2T mark (short mark) by means of the short mark asymmetry measuring unit 6 (#4), and offsets the level of the RF signal so as to remove the asymmetry in the 2T mark (short mark) by means of the RF signal offset unit 7. The information reproducing apparatus 1 then continues the reproduction of information on the optical disc (#1) to repeat the process from the step #1. If there is no asymmetry (NO at #3), the information reproducing apparatus 1 continues the reproduction of information on the optical disc without offsetting the RF signal level (#1) to repeat the process from the step #1. In this manner, the information reproducing apparatus 1 decodes binary data based on an RF signal offset so as to remove an asymmetry in a 2T mark (short mark), for reproduction of information recorded on an optical disc.

According to the information reproducing apparatus 1 described above, RF signals are offset so as to remove asymmetries in RF signals corresponding to the 2T mark or shortest recording mark, i.e., corresponding to a recording mark most likely to occur. This allows RF signals corresponding to the recording mark most likely to occur to be reliably distinguished from noise components as well as allowing proper input signals to be provided to the PLL circuit for improvement of the pull-in performance of the PLL circuit. Therefore, the error rate in decoding binary data can be decreased for improved performance in reproduction of information on an optical disc. Accordingly, stable reproduction of information and a reliable system can be provided. Moreover, since the PRML method is adopted for decoding binary data, the information reproducing apparatus 1 is suitable for reproducing information on a high-density optical disc. Accordingly, the information reproducing apparatus 1 can provide further improved performance in reproduction of information on a high-density optical disc.

The present invention has been described above using a presently preferred embodiment, but those skilled in the art will appreciate that various modifications are possible. For example, the information reproducing apparatus 1 according to the above described embodiment is designed to reproduce information on an optical disc with information recorded in the form of 2T to 14T recording marks. Alternatively, the present invention can be applied to an information reproducing apparatus that is designed to reproduce information on an optical disc with information recorded in the form of 3T to 14T recording marks (optical disc with a 3T mark as the short mark or shortest recording mark). In this case, the short mark asymmetry measuring unit 6 is modified to measure/calculate an asymmetry in an RF signal corresponding to the 3T mark. Likewise, the RF signal offset unit 7 is modified to offset RF signals so as to remove asymmetries in RF signals corresponding to the 3T mark. The information reproducing apparatus 1 can be designed to decode binary data by the level slice method instead of the PRML method. Further, the present invention can be applied to an information reproducing apparatus having a magnetic head in place of the optical head 2 for reproduction of information recorded on a hard disk.

This application is based on Japanese patent application 2005-338070 filed Nov. 24, 2005, the contents of which are hereby incorporated by reference.

What is claimed is:

1. An information reproducing apparatus comprising:
reading means for reading lengths and arrangement of recording marks from a recording medium on which several types of recording marks having different lengths are recorded in an arrangement to represent binary data, and outputting reproduced signals corresponding to the lengths and arrangement of the recording marks;
decoding means for decoding the binary data represented by the lengths and arrangement of the recording marks on the recording medium based on the reproduced signals output from the reading means;
asymmetry measuring means for measuring an asymmetry in a reproduced signal of the reproduced signals output from the reading means that corresponds to a short mark, the short mark being a shortest recording mark among the several types of recording marks; and
signal offset means for offsetting the reproduced signals so as to remove the asymmetry in the reproduced signal corresponding to the short mark based on the measurement by the asymmetry measuring means,
wherein the decoding means decodes the binary data based on the reproduced signals offset by the signal offset means.

2. The information reproducing apparatus according to claim 1,
wherein the decoding means is a partial response maximum likelihood (PRML) decoder that decodes binary data by a PRML method,
wherein, taking T as a basic recording cycle for recording marks on the recording medium, the short mark is a 2T mark having a length of 2T.

3. The information reproducing apparatus according to claim 2, wherein the recording medium is an optical disc.

4. The information reproducing apparatus according to claim 1, wherein the recording medium is an optical disc.
